(19) United States
(12) Patent Application Publication
(10) Pub. No.: US 2007/0213166 A1
(43) Pub. Date: Sep. 13, 2007

(54) Double Differential Assembly

(76) Inventor: Theodor Gassmann, Siegburg (DE)

Correspondence Address: Dickinson Wright PLLC, 38525 Woodward Avenue, Suite 2000, Bloomfield Hills, MI, 48304, US

(21) Appl. No.: 11/684,151

(22) Filed: Mar. 9, 2007

(30) Foreign Application Priority Data
Mar. 9, 2006 (DE) 10 2006 010 891.4

(51) Int. Cl. F16H 48/06

(52) U.S. Cl. 475/230

(57) ABSTRACT

A differential assembly with a first differential drive (15) having a differential cage (14) rotatingly drivable around an axis of rotation (A), a plurality of differential spur gears (17) rotating with the differential cage (14), and crown gears (18, 19) coaxial with the axis of rotation (A) and engaging the spur gears (17). A second differential drive (16) is arranged inside the first differential drive (15), and has a differential carrier (20), a plurality of differential gears (26) rotating jointly with the differential carrier (20), and sideshaft gears (27, 28) coaxial with the axis of rotation (A) and engaging the differential gears (26). The first crown gear (18) is connected in respect of drive to the differential carrier (20) of the second differential drive (16) and the second crown gear (19) is connected in respect of drive to a hollow shaft (22) extending coaxially relative to the axis of rotation (A).

### TECHNICAL FIELD

The invention relates to a differential assembly for use in the driveline of a four-wheel drive motor vehicle.

### BACKGROUND OF THE INVENTION

Four wheel drive vehicles can be divided into those which comprise an automatically connectable four wheel drive wherein a primary axle is permanently driven and a secondary axle is connected when required (hang-on), and those which comprise a permanent four wheel drive wherein both axles are permanently driven. The design of the driveline is largely determined by the arrangement of the engine in the motor vehicle, i.e. whether it is a front or rear engine and whether it is a longitudinal or transverse arrangement.

To permit differential movements between the two driven axles and to prevent any torsion in the driveline, a transfer box is normally used with a central differential. The two driven axles each comprise an axle differential which generates a differential effect between the two sideshafts. DE 103 53 415 A1 proposes a transfer box for driving a front axle and a rear axle of a multi-axle drive motor vehicle. The sideshaft gears are provided in the form of crown gears and the differential gears engaging same are cylindrical spur gears.

U.S. Pat. No. 5,107,951 discloses a motor vehicle with a permanent four-wheel drive and a longitudinally mounted front engine. For distributing the torque to the four wheels, a double differential drive with two bevel gear differentials positioned one inside the other is provided. The outputs of the differentials are connected to the sideshafts in such a way that each two sideshafts positioned diagonally opposite one another have a differential effect relative to one another.

DE 33 11 175 A1 proposes a differential assembly with two differential drives for multi-axle driven motor vehicles, which differential drives are connected and arranged in series and connected in respect of drive. The first differential drive divides the torque between the front axle and the rear axle. The second differential drive distributes the torque to the two sideshafts of the associated axle. The first differential drive is provided in the form of a bevel gear differential, a spur gear differential or a planetary differential.

### SUMMARY OF THE INVENTION

The present invention provides a self-locking differential assembly for use in the driveline of a motor vehicle which is permanently driven by four wheels, which permits a flexible distribution of torque, and which comprises a compact design and is easy to produce.

A first solution in accordance with an embodiment of the invention provides a differential assembly for use in the driveline of a motor vehicle with a plurality of driven axles. The assembly comprises a first differential drive in the form of a crown gear differential, the crown gear differential having a differential cage which is drivable so as to rotate around an axis of rotation, a plurality of spur gears in the form of differential gears jointly rotating with the differential cage, and a first crown gear and a second crown gear which are arranged coaxially relative to the axis of rotation and engage the spur gears. The differential assembly further comprises a second differential drive arranged coaxially relative to the axis of rotation inside the first differential drive. The second differential drive has a differential carrier, a plurality of differential gears jointly rotating with the differential carrier, and a first sideshaft gear and a second sideshaft gear which are arranged coaxially relative to the axis of rotation and engage the differential gears. The first crown gear is connected in a rotationally fast way to the differential carrier of the second differential drive, and the second crown gear is connected in a rotationally fast way to a hollow shaft extending coaxially relative to the axis of rotation.

The advantage of the inventive differential assembly is that it has a compact design and features a flexible distribution of torque to the first and to the second axle, and to the first and the second sideshaft of the first axle. The spur gears serve as the input part whereas the crown gears form the output parts of the first differential drive. Thus, one part of the torque is transmitted to the first axle via the first crown gear, the differential carrier and the second differential drive, whereas the other part of the torque is transmitted to the second axle via a second crown gear and the output shaft. By using a crown gear differential as the outer differential, the assembly features a particularly short axial length, which is advantageous in cases where it is used in motor vehicles with a transversely arranged front engine. The spur gears are cylindrical and engage radial teeth of the crown gears. The spur gears and the crown gears can also be slightly conical in shape without there occurring a substantial change in the axial length. A further advantage results from the small number of parts of the differential assembly which can thus be produced in a cost-effective way. Some parts like the differential carrier and the gears can be cost-effectively produced from sintered metal.

According to one embodiment, the differential cage has several parts and comprises a first cage part, a second cage part and an annular-disc-shaped driving gear which is held between the cage parts and in which the spur gears are received. The driving gear can include recesses which extend radially outwardly from a free inner circumferential face and in which the spur gears are rotatably held. The hollow chamber formed between the gears is largely filled, so that if there occurs a relative rotation of the gears relative to one another, there is generated a locking effect as a result of the friction forces at the tooth heads.

According to a further embodiment, the crown gears each comprise a contact face which is axially opposed to the crown gear teeth, and a friction coupling is arranged between the contact face and the differential cage. When differential speeds occur between the two axles, the crown gears rotate relative to one another, and the axial expanding forces acting between the differential gears and the crown gears have a loading effect on the friction couplings. The locking effect leads to a reduction of the speed differential between the two axles. The friction couplings may include at least one outer plate connected to the differential carrier in a rotationally fast way and at least one inner plate connected to the associated crown gear in a rotationally fast way, and if several outer plates and inner plates are used, these are arranged so as to axially alternate. The locking value can be increased by providing a greater number of friction plates.

As an alternative to the embodiment comprising friction couplings, the crown gears can be axially displaceable and each can comprise a conical contact face extending in an axially opposite direction to the crown gear teeth. Between the conical contact face of the first crown gear and the differential cage, at least one first pair of friction faces are provided. Between the conical contact face of the second crown gear and the differential cage, at least one second pair of friction faces for generating a locking moment are provided. The first and the second pairs of friction faces can be formed by direct contact or by intermediate friction discs.

According to yet another embodiment, the first crown gear is annular-disc-shaped and comprises inner teeth, which, in a rotationally fast way, engage corresponding outer teeth of the differential carrier of the second differential drive. The second crown gear is annular-disk-shaped and comprises inner teeth which, in a rotationally fast way, engage corresponding outer teeth of a hollow gear which is connected to the hollow shaft from where the driving moment is transmitted to the second axle.

A second solution provides a differential assembly for use in the driveline of a motor vehicle with a plurality of driven axles, comprising a first differential drive in the form of a crown gear differential. The first differential drive has a differential cage which is rotatingly drivable around an axis of rotation. A first crown gear is firmly connected to the differential cage, and a second crown gear is rotatably held in the differential cage coaxially relative to the axis of rotation. A plurality of pairs of inter-engaging spur gears of which a first spur gear engages the first crown gear and a second spur gear engages the second crown gear is also included. The differential assembly further comprises a second differential drive which is arranged coaxially relative to the axis of rotation and inside the first differential drive. The second differential drive has a differential carrier, a plurality of differential gears rotating jointly with the differential carrier around the axis of rotation, as well as a first sideshaft gear and a second sideshaft gear which are arranged coaxially relative to the axis of rotation and engage the differential gears. The spur gears of the crown gear differential rotate jointly with the differential carrier of the second differential drive around the axis of rotation, and the second crown gear is connected in a rotationally fast way to a hollow shaft extending coaxially relative to the axis of rotation.

This embodiment has the same advantages as the first solution. In the present case, the first crown gear serves as the input part, whereas the second crown gear and the pairs of spur gears constitute the output parts of the first differential drive. A first torque flow extends over the pairs of spur gears, the differential carrier and the second differential drive to the first axle, whereas a second torque flow is transmitted over the second crown gear and the hollow shaft to the second axle. If a speed differential occurs between the axles, the crown gears rotate relative to one another, with the pumping effect of inter-engaging gear teeth and the friction forces generating a locking effect, which leads to a reduction of the speed differential between the two axles.

According to one embodiment, the two spur gears are cylindrical and comprise straight teeth. At least one of the two spur gears intersects the axis of rotation at a distance therefrom, wherein the crown gear engaging the spur gear comprises helical teeth. The other spur gear can be arranged radially relative to the axis of rotation, in which case the associated crown gear would comprise radial teeth. The differential cage can be produced in several parts and comprises a first cage part, a second cage part and an annular-disc-shaped driving gear held therebetween. The first crown gear can be produced so as to be integral with the first cage part of the differential cage, which results in a particularly small number of part and a simple assembly procedure.

The differential carrier, on its radial outside, comprises an annular-disc-shaped portion which holds the pairs of spur gears and, on its radial inside, a sleeve-shaped portion which receives the differential gears. The annular-disc-shaped portion largely fills the space formed between the crown gears. For increasing the locking effect, it is thus possible to utilise the pumping effect of the engaging teeth and, respectively the friction forces at the teeth of the spur gears when the crown gears rotate relative to one another. According to another embodiment, the first and the second crown gear are rotatably supported via inner cylindrical faces on an outer face of the sleeve-shaped portion. There is thus no need for additional bearing parts.

Both solutions are advantageous in that the spur gears, with reference to the axis of rotation A, are positioned axially in the region of the differential gears. There is thus achieved a symmetric arrangement with a short axial length. The first and the second crown gear can have identical numbers of teeth, thus ensuring a uniform distribution of torque, or they can have different numbers of teeth, which leads to an asymmetric distribution of torque between the axles. In one embodiment, the second differential drive is received in the differential cage of the first differential drive, with the sideshaft gears being at least indirectly axially supported via contact faces against the differential cage.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should be made to the embodiments illustrated in greater detail in the accompanying drawings and described below by way of examples of the invention.

FIG. 1 shows the basic principles of a driving axle of a four-wheel drive motor vehicle having an inventive differential assembly in a first embodiment.

FIG. 2 is a longitudinal section through the differential assembly according to FIG. 1 in a modified embodiment.

FIG. 3 is a longitudinal section through an inventive differential assembly in a third embodiment.

FIG. 4 is a longitudinal section through a differential assembly in a fourth embodiment.

FIG. 5 shows an inventive differential assembly in a fifth embodiment in half a longitudinal section (upper half of the Figure) and in a circumferential section (lower half of the Figure).

FIG. 6 shows an inventive differential assembly in a sixth embodiment in half a longitudinal section (upper half of the Figure) and in a circumferential section (lower half of the Figure).

### DETAILED DESCRIPTION OF THE DRAWINGS

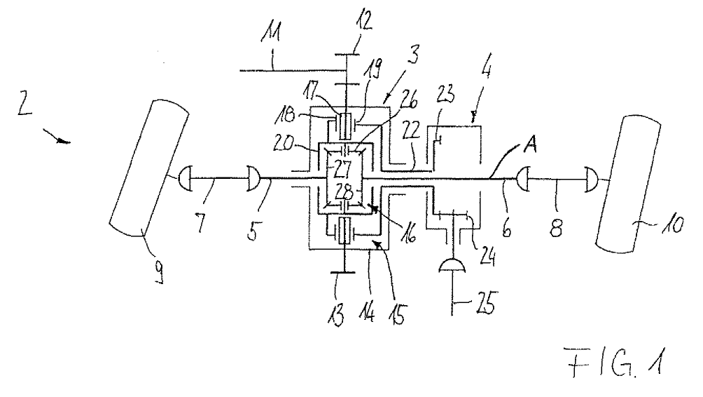

FIG. 1 shows the front axle 2 of a four-wheel drive motor vehicle (not illustrated in greater detail). The front axle 2 can be seen to comprise a double differential assembly 3, an angle drive 4, two sideshafts 5, 6, two driveshafts 7, 8 connected thereto and two wheels 9, 10. The double differential assembly 3 is driven via a driveshaft 11 with a pinion 12 of an engine-gearbox unit (not shown). The teeth of the pinion 12 engage those of the driving gear 13 which is connected to a differential cage 14 in a rotationally fast way. The double differential assembly 3 comprises an outer first differential drive 15 for dividing the introduced torque and distributing same to the front axle and the rear axle, as well as a second differential drive 16 which is positioned inside the first differential drive 15 and whose purpose it is to distribute the torque transmitted to the front axle 2 between the two sideshafts 5, 6. The first differential drive 15 permits a differential effect between the front axle and the rear axle, whereas the second differential drive 16 has a differential effect between the two sideshafts 5, 6 in order to allow the sideshafts 5, 6 to rotate with different speeds.

The first differential drive 15 is provided in the form of a crown gear differential and, apart from the differential cage 14, comprises a plurality of spur gears 17 in the form of differential gears which, jointly with the differential cage 14, rotate around the axis of rotation A; as well as a first and a second crown gear 18, 19 in the form of sideshaft gears whose teeth engage those of the spur gears 17 and are supported in the differential cage 14 so as to be coaxially rotatable around the axis of rotation A. The spur gears 17 are cylindrical and each engage radial teeth of the crown gears 18, 19. However, the spur gears 17 and the crown gears 18, 19 can also be slightly conical. The first crown gear 18 is firmly connected to a differential carrier 20 which serves as the differential cage for the second differential drive 16. The second crown gear 19 is drivingly connected to a hollow shaft 22 constituting the output shaft which extends coaxially relative to the axis of rotation A. The hollow shaft 22 drives the input gear 23 of the angle drive 4, whose teeth engage those of the output pinion 24. The output pinion 24, in turn, for the purpose of transmitting torque to the rear axle, is connected to a propeller shaft 25 only part of which is shown.

The second differential drive 16, apart from the differential carrier 20, comprises a plurality of differential gears 26 which, together with the differential carrier 20, rotate around the axis of rotation A, as well as a first and a second sideshaft gear 27, 28. The two sideshaft gears 27, 28 are arranged opposite one another in the differential carrier 20 to as to extend coaxially relative to the axis of rotation A, with their teeth engaging those of the differential gears 26. The second differential drive 16 is provided in the form of a bevel gear differential, i.e. the differential gears 26 and the sideshaft gears 27 are bevel gears. The first sideshaft gear 27 is connected to the first sideshaft 5, whereas the second sideshaft gear 28 is connected to the second sideshaft 6. The second sideshaft 6 is positioned on the axis of rotation inside the hollow shaft 22 and passes through the angle drive 4. The type of coaxial arrangement of the second differential drive 16 inside the first differential drive 15 combined with the shape of the first differential drive in the form of a crown gear differential is advantageous in that the entire assembly comprises a short axial length. This is particularly advantageous if the assembly is used in connection with a transversely mounted engine.

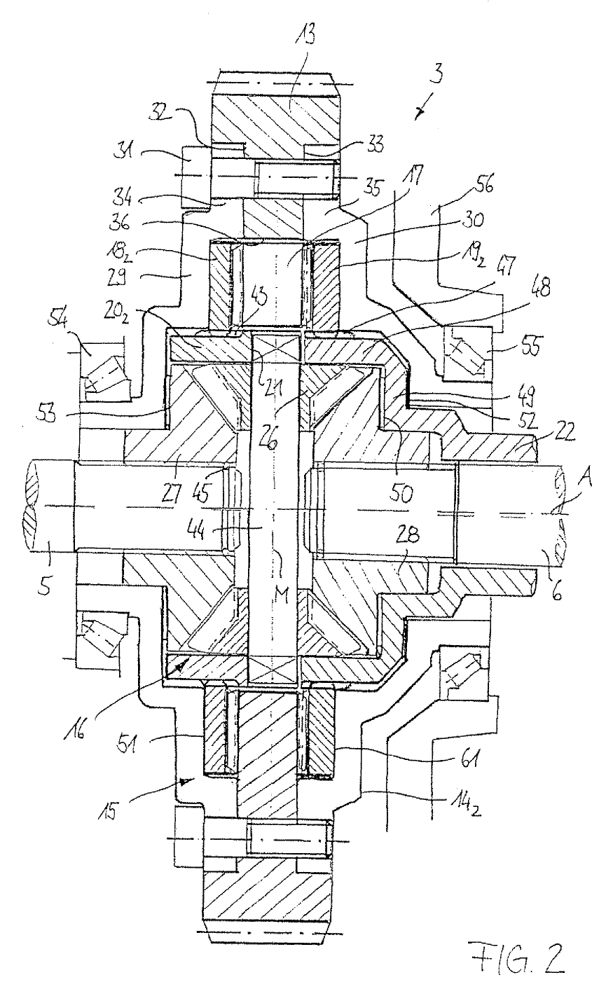

The double differential assembly 3 as shown in FIG. 2 largely corresponds to that illustrated in FIG. 1 giving the basic principles of the double differential assembly. To that extent, reference is made to the above description, with identical components having been given identical reference numbers and with modified components having been given the number two in the form a subscript.

It can be seen that the differential cage 14₂ is composed of several parts and comprises a first carrier part 29, a second carrier part 30 and the driving gear 13 axially arranged therebetween. The driving gear 13 is annular-disc-shaped and comprises two axially opposed grooves 32, 33 which are engaged by flanges 34, 35 of the first and the second carrier part 29, 30. In the flanges and in the driving gear there is provided a plurality of circumferentially distributed bores for connecting said components by means of bolts 31 or other fasteners. The driving gear 13 comprises radial recesses 36 which extend from a free inner circumferential face and which each receive a spur gear 17 which rotates jointly with the driving gear 13 around the axis of rotation A. The crown gears 18₂, 19₂ which form output parts of the first differential drive 15 each comprise a contact face which extends in an axial direction opposed to that of the crown gear teeth and which is axially supported against the differential cage 14₂.

For torque transmitting purposes, the first crown gear 18₂, on its radial inside, comprises inner teeth which, in a rotationally fast way, engage outer teeth 43 of the tubular differential carrier 20₂. The first crown gear 18₂ thus rotates jointly with the differential carrier 20₂ around the axis of rotation A. At its end facing the central plane M of the differential, the differential carrier 20₂ comprises radial recesses 21 in which there is held a journal 44 for receiving the differential gears 26 to be able to rotate with the differential carrier 20₂ around the axis of rotation A. The teeth of the differential gears 26 engage those of the sideshafts gears 27, 28 which are connected to the sideshafts 5, 6 via a plug-in connection and which are axially secured by securing rings 45.

The second crown gear 19₂, on its radial inside, by way of inner teeth and in a rotationally fast way, engages corresponding outer teeth 47 of the hollow gear 48 which is connected to the hollow shaft 22. The hollow gear 48, the hollow shaft 22 and an intermediate stepped transitional portion 49 are provided in one bell-shaped piece. The sideshaft gear 28 is axially supported via a friction-reducing abutment disc 50 against the radial supporting portion 49 which, in turn, is axially supported via an axial bearing 52 against a radial face of the differential cage 14₂. The opposed sideshaft gear 27 is directly axially supported against a radial face of the differential cage 14₂ via a friction-reducing abutment disc 53. The differential cage 14₂ is rotatably supported by rolling contact bearings 54, 55 in a stationary housing 56 (shown only partially). The crown gears 18₂, 19₂ on their sides removed from the central plane M, each comprise a contact face 51, 61, by which they are supported against the differential cage 14₂.

In the present embodiment, the differential cage 14₂ and, respectively, the spur gears 17 jointly rotating therewith around the axis of rotation A serve as the input part, whereas the crown gears 18₂, 19₂ form the output parts of the first differential drive 15₂, with one part of the torque being transmitted to the front axle 2 via the first crown gear 18₂, the differential carrier 20₂ and the second differential drive 16; whereas the other part of the torque is transmitted to the rear axle via the second crown gear 19₂ and the output shaft 22.

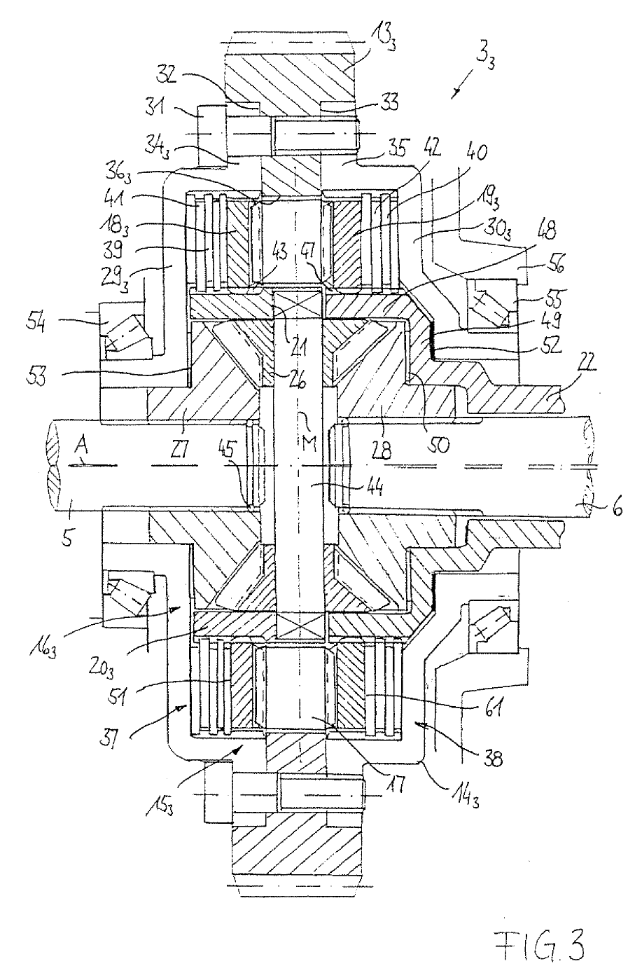

The differential assembly 33 shown in FIG. 3 largely corresponds to that shown in FIG. 2. To that extent, reference is made to the description of same, with any modified components of the present embodiment being provided with the number three in the form of a subscript.

The only modification of the embodiment to FIG. 2 consists in that, in the present embodiment, there are provided friction couplings 37, 38 between the contact faces 51, 61 of the crown gears 18₃, 19₃ and of the differential cage 14₃. The friction couplings 37, 38 each comprise a plurality of outer plates 39, 40 which, on the radial outside, engage in a rotationally fast way a toothed profile in the differential cage 14₃, as well as a plurality of inner plates 41, 42 arranged so as to alternate with the outer plates 39, 40. The inner plates 41 of the first friction coupling 37, by means of inner teeth, engage the outer teeth 43₃ of the differential carrier 20₃. The inner plates 42 of the second friction coupling 38, by means of their inner teeth, engage, in a rotationally fast way, outer teeth 47₂ of the hollow gear 38₃ which is connected to the hollow shaft 22₃.

When speed differentials occur between the front axle and the rear axle, the crown gears 18₃, 19₃ rotate relative to one another, with the expanding forces acting between the differential gears 17₃ and the crown gears 18₃, 19₃ loading the friction couplings 37, 38 away from the central plane M. There is thus achieved a locking effect which leads to a reduction of the speed differential between the two axles.

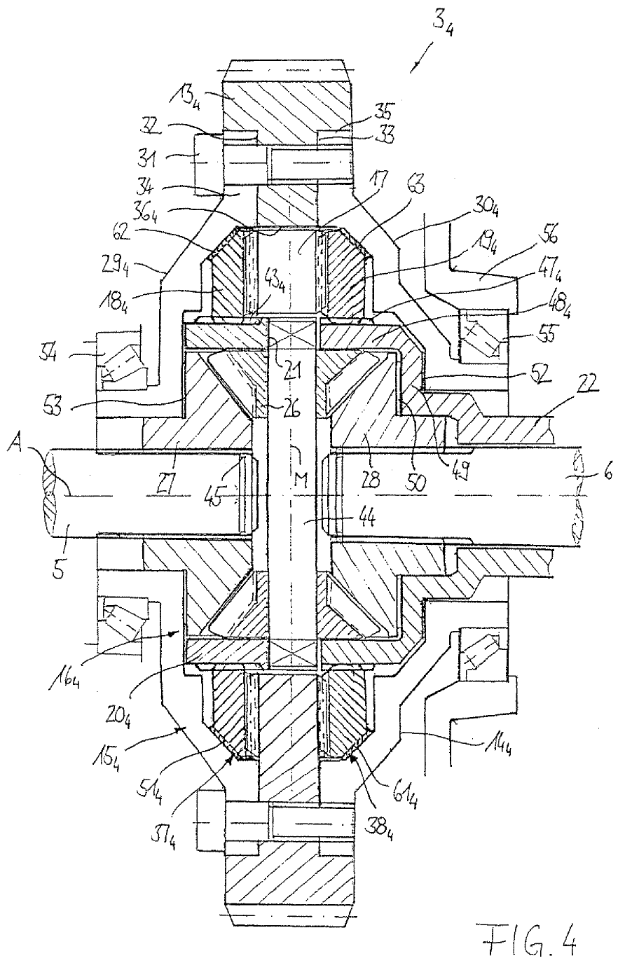

The double differential assembly 34 as shown in FIG. 4 largely corresponds to the embodiments shown in FIGS. 2 and 3. To that extent, as far as their common features are concerned, reference is made to the above description, with any modified components of the present embodiment having been provided with the number four in the form of a subscript.

The present embodiment is characterised in that the crown gears 18₄, 19₄, on their sides removed from the central plane M, each comprise a conical contact face 51₄, 61₄ by means of which they are supported against the differential cage 14₄. Between the contact face 51₄, 61₄ and the associated supporting face of the differential cage 14₄ there is arranged a friction disc 62, 63. The friction discs 62, 63 thus form pairs of friction couplings 37₄, 38₄ in the form of friction faces, so that if a speed differential occurs, friction forces are generated which have a locking effect.

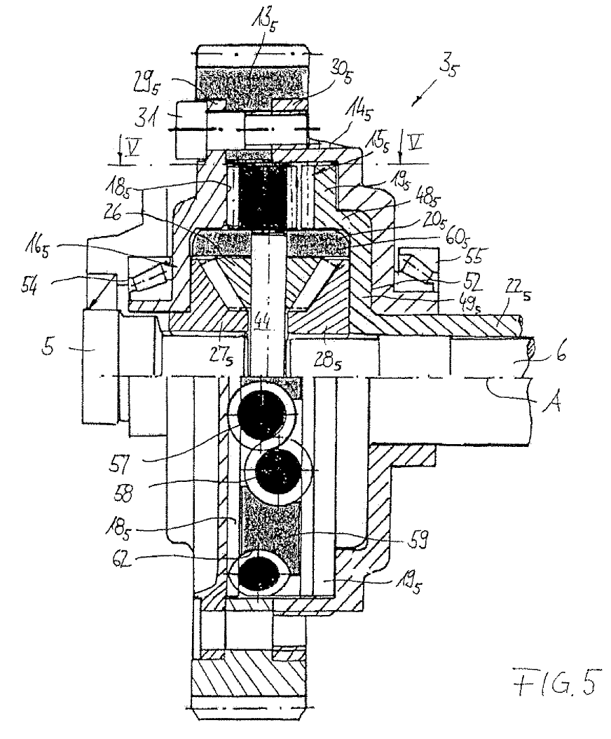

FIG. 5 shows a further embodiment of an inventive double differential assembly 3₅ which largely corresponds to the embodiments shown in FIGS. 1 and 2. To that extent, as far as their common features are concerned, reference is made to the above description, with any modified components of the present embodiment having been provided with the number five in the form of a subscript. The upper half of the Figure shows a double differential assembly in half a longitudinal section, whereas in the lower half of the Figure there is shown a circumferential section according to sectional line V-V.

The differential cage 14₅ is produced in several parts and comprises a first carrier part 29₅ and second carrier part 30₅ and the driving gear 13₅ axially positioned therebetween. The driving gear 13₅ is annular-disc-shaped and comprises two axially opposed annular recesses which are engaged by the flanges of the first and of the second carrier part 29₅, 30₅. Said components are connected by bolts 31. The first carrier part 29₅ is produced so as to be integral with the first crown gear 18₅ which serves as an input part. The torque is transmitted via several pairs of spur gears 57, 58 to the second crown gear 19₅ for driving the rear axle on the one hand and to the differential carrier 20₅ for driving the front axle on the other hand. For this purpose, the pairs of spur gears 57, 58 are rotatably held on the differential carrier 20₅ and jointly rotate therewith around the axis of rotation A, with the first spur gear 57 engaging the first crown gear 18₅ and the second spur gear 58 engaging the second crown gear 19₅. The second crown gear 19₅ is produced so as to form one piece with the hollow gear 48₅, the transitional portion 49₅ and the output shaft 22₅.

The differential carrier 20₅ is composed of an annular-disc-shaped portion 59 receiving the spur gears 57, 58 and a sleeve-shaped portion 60₅ which, on the radial inside, adjoins the annular-disc-shaped portion 59 and in which the journals 44₅ are received. The two portions 59, 60₅ can be produced in one piece or they can be produced separately and subsequently connected to one another, for example by welding. The sleeve-shaped portion 60₅ comprises a cylindrical outer face relative to which the first and the second crown gear 18₅, 19₅ are supported via cylindrical inner faces. The sleeve-shaped portion 60₅ extends along the length of the second differential 16₅ and is axially flush with the contact faces of the sideshaft gears 27₅, 28₅. The first sideshaft gear 27₅ is axially supported against the differential cage 14₅, whereas the second sideshaft gear 28₅ is supported against the radial portion 49₅ of the hollow shaft 22₅. The annular-disc-shaped portion 59 of the differential carrier 20₅, on its radial outside, comprises pockets 62 which are formed by overlapping circles and which there are positioned the spur gears 57, 58. The annular-disc-shaped portion 59 largely fills the annular chamber formed between the crown gears 18₅, 19₅. The two spur gears 57, 58 are cylindrical and comprise parallel axes one of which is positioned perpendicularly on the axis of rotation A and intersects same, with the other one perpendicularly intersecting the axis of rotation A at a distance. The first crown gear 18₅ and the two spur gears 57, 58 comprise straight teeth, whereas the second crown gear 19₅ comprises helical teeth because of the axial offset of the second spur gear.

In this embodiment, the first crown gear 18₅ serves as the input part, whereas the second crown gear 19₅ and the pairs of spur gears 57, 59 form the output parts of the first differential drive 15₅. One part of the torque is transmitted to the front axle 2 via the pairs of spur gears, the differential carrier 20₅ and the second differential drive 16₅, whereas the other part of the torque is transmitted to the rear axle via the second crown gear 19₅ and the output shaft 22₅. When there occur speed differentials between the front axle and the rear axle, the crown gears 18₅, 19₅ rotate relative to one another. The pumping effect of the inter-engaging gear teeth and the friction of the teeth in the pockets generate a locking effect which leads to a reduction in the speed differential of the two axles.

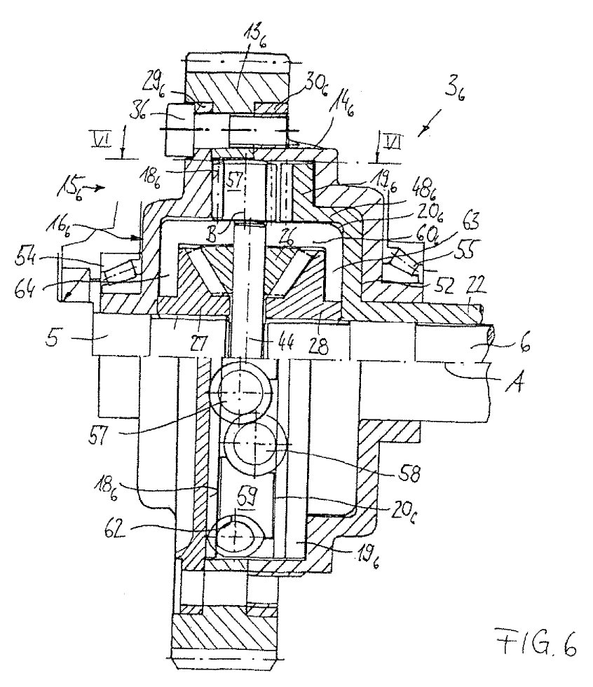

The double differential assembly 3₆ shown in FIG. 6 very largely corresponds to that illustrated in FIG. 5, which is the reason why reference is hereby made to the above description. The only difference consists in the design of the differential carrier 20₆ which is here cage-shaped and comprises flange-shaped portions 63, 64 which adjoin the sleeve-shaped portion 60₆ and which axially support the sideshaft gears 27₆, 28₆. The expanding forces of the second differential drive 16₆ thus act on the differential carrier 206 only and are not transmitted to the differential cage 14₆. As can also be seen, the two spur gears 57, 58 are cylindrical and comprise parallel axes B one of which is positioned perpendicularly on the axis of rotation A and intersects same, with the other one perpendicularly intersecting the axis of rotation A at a distance.

While the invention has been described in connection with several embodiments, it should be understood that the invention is not limited to those embodiments. Rather, the invention covers all alternatives, modifications, and equivalents as may be included in the spirit and scope of the appended claims.

What is claimed is:

1. A differential assembly for use in the driveline of a motor vehicle with a plurality of driven axles, comprising:
a first differential drive in the form of a crown gear differential, said first differential drive having a differential cage rotatingly drivable around an axis of rotation (A), a plurality of spur gears as differential gears and which rotate jointly with the differential cage, and a first crown gear and a second crown gear which are arranged coaxially relative to the axis of rotation (A) and which engage the spur gears; and
a second differential drive arranged coaxially relative to the axis of rotation (A) inside the first differential drive, said second differential drive having a differential carrier, a plurality of differential gears rotating jointly with the differential carrier, and a first sideshaft gear and a second sideshaft gear which are arranged coaxially relative to the axis of rotation (A) and which engage the differential gears,
wherein the first crown gear is connected to the differential carrier of the second differential drive in a rotationally fast way and wherein the second crown gear is connected in a rotationally fast way to a hollow shaft extending coaxially relative the axis of rotation (A).

2. A differential assembly according to claim 1, wherein the differential cage comprises a first cage part, a second cage part and an annular-disc-shaped driving gear which is held between said cage parts and in which the spur gears are received.

3. A differential assembly according to claim 2, wherein the spur gears are rotatably held in the annular-disc-shaped driving gear in radial recesses starting from an inner circumferential face.

4. A differential assembly according to claim 1, wherein the first crown gear is annular-disc-shaped and comprises inner teeth, which, in a rotationally fast way, engage corresponding outer teeth of the differential carrier of the second differential drive.

5. A differential assembly according to claim 1, wherein the second crown gear is annular-disc-shaped and comprises inner teeth which, in a rotationally fast way, engage corresponding outer teeth of a hollow gear which is connected to the hollow shaft.

6. A differential assembly according to claim 1, wherein the crown gears are axially displaceable and each comprise a contact face extending in an axially opposite direction to the crown gear teeth, wherein, between the contact face of the first crown gear and the differential cage, there is provided a first friction coupling and, wherein, between the contact face of the second crown gear and the differential cage, there is provided a second friction coupling for generating a locking moment.

7. A differential assembly according to claim 6, wherein the first and the second friction coupling are multi-plate couplings and comprise outer plates and inner plates which are arranged so as to alternate in the axial direction and which are axially displaceable.

8. A differential assembly according to claim 6, wherein inner teeth of inner plates of the first friction coupling engage outer teeth of the differential carrier in a rotationally fast and axially displaceable way, and outer teeth of outer plates engage inner teeth in the differential cage in a rotationally fast and axially displaceable way.

9. A differential assembly according to claim 6, wherein inner teeth of inner plates of the second friction coupling engage outer teeth of the hollow gear in a rotationally fast and axially displaceable way, and outer teeth of outer plates engage inner teeth in the differential cage in a rotationally fast and axially displaceable way.

10. A differential assembly according to claim 1, wherein the crown gears are axially displaceable and each comprise a conical contact face extending in an axially opposite direction to the crown gear teeth, wherein, between the conical contact face of the first crown gear and the differential cage there is provided a first pair of friction faces and wherein, between the conical contact face of the second crown gear and the differential cage, there is provided a second pair of friction faces for generating a locking moment.

11. A differential assembly for use in the driveline of a motor vehicle with a plurality of driven axles, comprising:
a first differential drive in the form of a crown gear differential, said first differential drive having a differential cage which is rotatingly drivable around an axis of rotation (A), a first crown gear firmly connected to the differential cage, a second crown gear rotatably held in the differential cage coaxially relative to the axis of rotation (A), and a plurality of pairs of spur gears which engage one another and of which a first spur gear engages the first crown gear and a second spur gear engages the second crown gear;
a second differential drive which is arranged coaxially relative to the axis of rotation (A) and inside the first differential drive, said second differential drive having a differential carrier, a plurality of differential gears rotating jointly with the differential carrier around the axis of rotation (A), and a first sideshaft gear and a second sideshaft gear which are arranged coaxially relative to the axis of rotation (A) and engage the differential gears;
wherein the spur gears of the crown gear differential rotate jointly with the differential carrier of the second differential drive around the axis of rotation (A) and wherein the second crown gear is connected in a rotationally fast way to a hollow shaft extending coaxially relative to the axis of rotation (A).

12. A differential assembly according to claim 11, wherein at least one of the two spur gears intersects the axis of rotation (A) at a distance therefrom, and wherein the crown gear engaging the corresponding spur gear comprises helical teeth.

13. A differential assembly according to claim 11, wherein the differential cage comprises a first cage part, a second cage part and a disc-shaped driving gear held axially between said cage parts.

14. A differential assembly according to claim 11, wherein the first crown gear is integral with the differential cage.

15. A differential assembly according to claim 11, wherein, on its radial outside, the differential carrier comprises an annular-disc-shaped portion holding the pairs of spur gears and, on its radial inside, the differential carrier comprises a sleeve-shaped portion receiving the differential gears.

16. A differential assembly according to claim 15, wherein the annular-disc-shaped portion substantially fills a chamber formed between the crown gears.

17. A differential assembly according to claim 15, wherein, by inner cylindrical faces, the first and the second crown gears are rotatably supported on the sleeve-shaped portion.

18. A differential assembly according to claim 1, wherein, with reference to the axis of rotation (A), the spur gears are positioned axially in the region of the differential gears.

19. A differential assembly according to claim 11, wherein, with reference to the axis of rotation (A), the spur gears are positioned axially in the region of the differential gears.

20. A differential assembly according to claim 1, wherein the first crown gear and the second crown gear comprise the same number of teeth or different numbers of teeth.

21. A differential assembly according to claim 11, wherein the first crown gear and the second crown gear comprise the same number of teeth or different numbers of teeth.

22. A differential assembly according to claim 1, wherein the second differential drive is received in the differential cage, and the sideshaft gears are axially supported against the differential cage by contact faces.

23. A differential assembly according to claim 11, wherein the second differential drive is received in the differential cage, and the sideshaft gears are axially supported against the differential cage by contact faces.
